(19) United States
(12) Patent Application Publication
(10) Pub. No.: US 2014/0189572 A1
(43) Pub. Date: Jul. 3, 2014

(54) Ranking and Display of Results from Applications and Services with Integrated Feedback

(71) Applicant: MOTOROLA MOBILITY LLC, Libertyville, IL (US)

(72) Inventors: Johannes Peter Wilhelm Martens, San Francisco, CA (US); Michael D. McLaughlin, San Jose, CA (US)

(73) Assignee: Motorola Mobility LLC, Libertyville, IL (US)

(21) Appl. No.: 13/769,466

(22) Filed: Feb. 18, 2013

Related U.S. Application Data
(60) Provisional application No. 61/747,564, filed on Dec. 31, 2012.

(51) Int. Cl. G06F 3/0481

(52) U.S. Cl. CPC G06F 3/04817
USPC 715/780

(57) ABSTRACT

In response to user input, a predictive application mode is initiated that includes providing a user interface to select or enter user input. Based on the user input, multiple potentially relevant applications can be selected. The multiple applications can be executed with the user input as input to generate multiple results. The results can be analyzed to determine the relevancy and a ranked order. The results can then be displayed in a user interface that lists the results according the ranked order. User input can then be monitored to determine if a result, and the associated application, displayed in the ranked list is selected, or if the user enters the user input into an application that did not appear in the list. The user input detected by the monitoring process can be used as feedback to improve the predictive application selection process or that ranking of the results.

### BACKGROUND

With the proliferation of small, but powerful, portable computing devices, there has been an explosion of specialized applications and services that take advantage of the high performance network connectivity, location determination, cameras, and general computing power of such devices to provide timely and useful information to users for a wide range of purposes and situations. Although the abundance of choices of applications and services has provided users with a myriad options and created a highly competitive marketplace, it has also created user confusion and a certain level of stasis with respect to number of applications and services of which users are aware and actually use on a regular basis with any degree of success or efficacy.

In the mobile communication and computing arena, users can download and install small specialized applications, or “apps”, to their individual portable computing devices, e.g., smart phones, tablet computers, laptop computers, heads-up-display (HUD) glasses/goggle, wristwatch, and combinations thereof, to perform specific functions or engage in particular activities. Such functions and activities range from playing games and sharing photographs to banking and finding real estate properties. As used herein, the term application may refer to any type of standalone or Internet connected application, program, or subroutine executed in any layer in the computing environment, e.g., in the operating system, in the middleware layer, or as a top layer application. Due to the specific-purpose and atomic-nature of such stand-alone and Internet-connected applications, many real-world scenarios require a user to launch and use multiple applications and/or services to complete a real-world task, e.g., make a reservation for dinner at a restaurant and invite friends to the dinner.

In one example, a user might receive an email or short messaging service (SMS) message from a friend recommending or suggesting dinner at a particular restaurant. To read reviews of the restaurant to help the user decide if he/she would like to try the suggested restaurant, the user would need to either remember or copy the name of the restaurant, exit the email or SMS message application, and launch a restaurant review application, such as YELP®, that the user may know about or use on a regular basis. After reading the review in the restaurant review application, the user may then want to look at the location using a map application to determine where the restaurant is located. To look up the location, the user must exit the restaurant review application and launch a map application, at which point, the user may have to reenter or paste in the name or address of the restaurant. Once the user determines that he/she may want to try the restaurant, he/she may want to make a reservation at the restaurant using a restaurant reservation application, such as OpenTable®. To make the reservation, the user would need to exit the map application, launch the reservation application, and yet again, paste or enter in the name of the restaurant. Once the reservation is made, the user may wish to invite friends to join him/her at the restaurant via email. To do so, the user would have to exit the reservation application, launch the email application again, and compose an email with all the information discovered in each of the previously opened (and exited) applications manually.

While the above scenario is possible with conventional mobile computing operating systems and applications, such systems require that the user know the name of each application, the function and capabilities of each application, and know how to quickly launch the application from the user interface of his/her mobile computing device. Not only are such systems awkward and arduous to use to perform various everyday functions, such systems can also hinder, and in some scenarios prevent, a user from discovering new and useful applications or services already installed on, or otherwise available to, his/her mobile computing device. If the user does not know that an application exists for particular function, and does not actively go looking for it using a search engine, then it is unlikely that such a user will learn about or otherwise be exposed to the functionality and capabilities of various new applications and services.

### BRIEF DESCRIPTION OF THE DRAWINGS

FIG. 1 is a block diagram of a system for displaying results from predictive execution of applications, according to various embodiments of the present disclosure.

FIG. 2 is a block diagram of a results handler, according to various embodiments of the present disclosure.

FIGS. 3A and 3B are diagrams that illustrate a use scenario of an electronic device that displays ranked lists of results from predictively determined applications, according to various embodiments of the present disclosure.

FIG. 4 is a flowchart of a method for providing a display of the results of predictively determined applications, according to various embodiments of the present disclosure.

FIG. 5 is a flowchart of a method for automatically providing ranked results from predictively provided applications in response to text input, according to various embodiments of the present disclosure.

### DETAILED DESCRIPTION

Described herein are techniques for systems and methods for entering and displaying a predictive applications selection mode with feedback, and improving the predictive selection or ranking of application results with feedback. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

Various embodiments of the present disclosure include methods, that can include providing a control to initiate a predictive application selection mode. The predictive application selection mode causes display of a first graphical user interface that is superimposed over a second graphical user interface on a display device. Such embodiments, can further include receiving a first user input through the control, initiating the predictive application selection mode in response to the first user input, and receiving a second user input, such as text data, voice data, or image data, through the first graphical user interface. Such methods can also include determining multiple results from multiple applications to which the second user input is available as input, determining a ranked order of the multiple results, and displaying a third user interface comprising a list of a portion of the results based on the ranked order.

Other embodiments of the present disclosure include non-transitory computer-readable storage media containing instructions that, when executed, control a processor of a computer system to be configured for providing a control to initiate a predictive application selection mode. The predictive application selection mode causes display of a first graphical user interface that is superimposed over a second graphical user interface on a display device. Such embodiments can also include receiving a first user input through the control, initiating the predictive application selection mode in response to the first user input, receiving a second user input, such as text data, voice data, or image data, through the first graphical user interface, and determining multiple results from multiple applications, to which the second user input is available as input. Such embodiments can also include determining a ranked order of the multiple results, and displaying a third user interface comprising a list of a portion of the results based on the ranked order.

Various other embodiments of the present disclosure include an electronic device that can include one or more computer processors and a non-transitory computer-readable storage medium containing instructions, that when executed, control the computer processors to be configured for providing a control to initiate a predictive application selection mode. The predictive application selection mode causes display of a first graphical user interface that is superimposed over a second graphical user interface on a display device of the electronic device. Such embodiments can also include receiving a first user input through the control, initiating the predictive application selection mode in response to the first user input, receiving a second user input, such as text data, voice data, or image data, through the first graphical user interface, and determining multiple results from multiple applications, to which the second user input is available as input. Such embodiments can also include determining a ranked order of the multiple results, and displaying a third user interface comprising a list of a portion of the multiple results based on the ranked order.

Various embodiments of the present disclosure include a method, performed by a computing system, or other electronic device, for providing, in an electronic device, a control to initiate a predictive application selection mode, wherein the predictive application selection mode causes display of a first graphical user interface that is superimposed over a second graphical user interface on a display device of the electronic device. Such embodiments can also include receiving a first user input through the control, initiating the predictive application selection mode in response to the first user input, receiving a second user input, such as text data, voice data, or image data, through the first graphical user interface, and determining multiple results from multiple applications, to which the second user input is available as input. Finally, such embodiments can also include determining a ranked order of the plurality of results, and displaying a third user interface comprising a list of the at least a portion of the plurality of results based on the ranked order.

In some embodiments, the user interface for initiating the mode for predictively determining and executing applications, can include a persistent control, such as a dedicated physical button in the electronic device. In other embodiments, the user interface can include a multi-purpose or variable purpose control, such as an interactive button displayed on a touchscreen of the electronic device. In either embodiment, when the control is operated, the electronic device can initiate the mode.

In one embodiment, when the mode for predictively determining applications is initiated, a text selection user interface is superimposed onto an underlying user interface that is displaying one or more active applications on a display device. For example, the text selection user interface can include highlighted regions superimposed over the text displayed by the active applications. To select text from the active application displayed in the underlying user interface, a user can the select the highlighted regions superimposed over the desired text. As used herein the term “application” can refer to any program or service executed locally in an electronic device or remotely in another computer system connected to the electronic device by one or more electronic communication media.

Once the mode to predictively determine and execute various relevant applications is initiated, the electronic device can, in response to a selection of text made in the text selection user interface superimposed onto the underlying user interface, the electronic device can analyze the characteristics of the selected text. For example, such analysis can include recognizing that the selected text is referring to a time or date or a name. For example, the phrase, “the day after tomorrow,” can be analyzed to mean an actual date on the calendar relative to the day on which an email or SMS message containing the phrase was received or relative to the current date and time. Similarly, such analysis can also include recognizing selected or entered text as being a name, an address, a business, or other commonly known or used vernacular term.

The initial analysis of the text data, or any other type of user input, can also include executing an initial local query or search on data stored locally on the electronic device to determine any direct matches with the text data. For example, an electronic device, such as a smart phone, can execute the query or search on the data associated with locally stored contacts, SMS text messages and/or email messages. If the search results in a direct match, or a large number of matches, then various embodiments of the present disclosure can determine that the text is highly relevant to the user and may determine applications that would be used to access the locally stored matching data on the electronic device and presents these applications to the user in a list of potentially relevant results.

During, or after, the initial analysis is performed, various embodiments of the present disclosure include querying or searching local and/or remote category databases to determine a category with which the text might be associated. For example, if the text includes a title of the movie, then a search of the category databases can determine an associated category of the text data is “movies” or “movie titles”. Based on the determination of a category, various embodiments of the present disclosure can determine a predetermined and/or dynamically determine a set of various potentially applicable or relevant applications. Such sets of applications can be based on user preferences, crowd source opinions, advertisement space sales, and other factors that might indicate that a particular application might be applicable or helpful with respect to the particular category determined to be associated with the text.

Some or all of the applications determined to be associated or potentially relevant to the determine category can be executed in parallel. In response to running separate applications, various embodiments of the present disclosure can receive the results from the applications asynchronously, i.e., in the order in which results are returned or completed. In related embodiments, the results from the set of applications can be analyzed to determine the relevance of the results based on the strength of the results and/or other contexts of the user or the electronic device. The results from the set of applications can then be ranked according to the determined relevance of the results and displayed to the user according to the ranking. Such displays can include a link or other control operable by the user to launch the related application or view a more complete version of the results.

In related embodiments, electronic device can list the results in a user interface according to the ranked order. While the electronic device is displaying the list of results, electronic device can monitor user input to record which of the results and/or the associated applications are selected. Electronic device can then use that recorded information regarding the selected results and/or application as feedback in the future when predicting potentially relevant applications and/or for determining the relevance of the results returned from the predicted potentially relevant applications. The recorded information regarding the selected results and/or application can be stored on the electronic device, another local electronic device, or in a data store on a remote server or in a cloud computing environment. In embodiments in which the recorded information regarding the selected results and/or application is stored on a server or in a cloud computing environment, the information can be aggregated with the results of other users, or otherwise analyzed, to determining the relevance of the results returned from the predicted potentially relevant applications for the user of the electronic device or the users of other electronic device. Accordingly, the determination of relevancy of an result or application can be based on the behavior of a population of user over time.

In some scenarios, the prediction of potentially relevant applications can fail (e.g., either no relevant applications are determined or a user does not select any potentially relevant applications). In such situations, various embodiments of the present disclosure can continue to monitor user input after the user has exited or dismissed the list of ranked results to determine if the user initiates or launches another application or service with text similar to the text data used by the potentially relevant applications as input. In this way, the electronic device can learn user preferences by observing which applications or services the user uses in particular or specific contexts. By detecting text data entered into one or more applications that may not have been listed in the ranked results, the electronic device can use the information as feedback in the future when predicting potentially relevant applications and/or for determining the relevance of the results returned from the predicted potentially relevant applications.

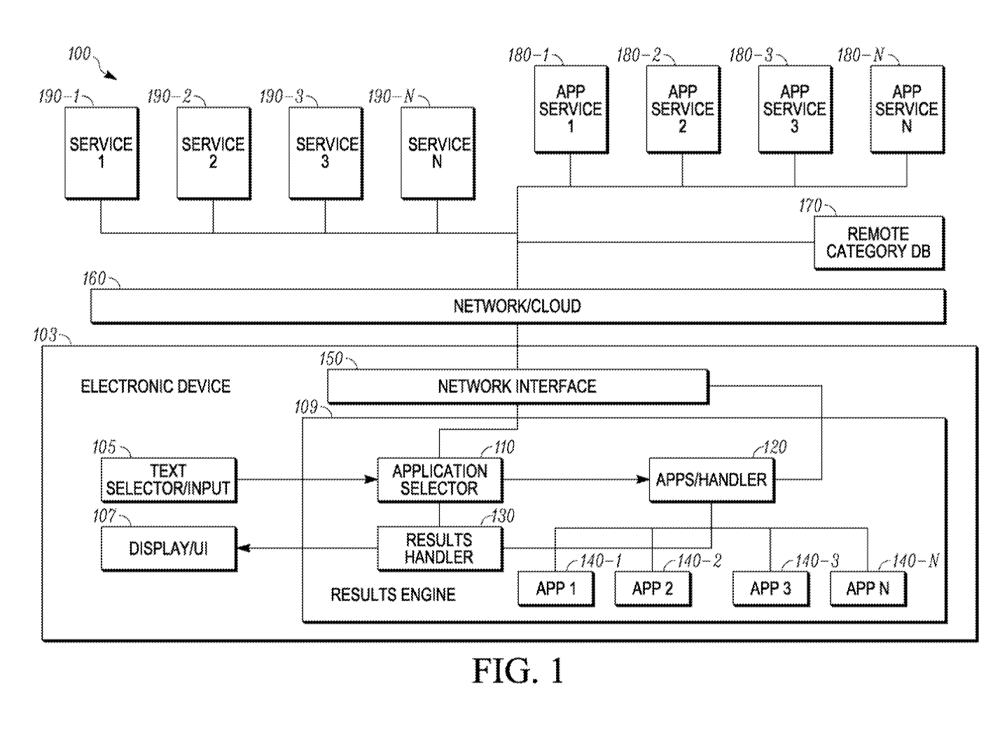

FIG. 1 illustrates a diagram of a system 100 for initiating a mode in electronic device for predictively determining sets of applications 140 for parallel execution in response to one or more contexts, such as text data or location, and displaying the results in a ranked order according to relevance, according to various embodiments of the present disclosure. Applications 140 included in the sets of applications 140 and the order in which they are ranked and displayed can be improved by feedback information provided by monitoring which applications 140, that may or may not be in the ranked list of applications 140, a user selects.

As shown, system 100 can include an electronic device 103 that includes a results engine 109, coupled to text selector/input device 105, display/UI device 107, and network interface 150. Electronic device 103 may include a smartphone, tablet device, laptop, set-top box, or other computer systems. In one embodiment, the results engine 109 can be coupled to network/cloud 160 through network interface 150. In such embodiments, the results engine 109 can communicate with services 190 and application support services (application services) 180 through the network/cloud 160. Network interface 150 can include various types of network interface cards and transceivers for communicating with the network/cloud 160. Accordingly, the network interface 150 and the network/cloud 160 can be configured to communicate with one another over various types of electronic communication protocols including, but not limited to, Wi-Fi, general packet radio service (GPRS), global system for mobile communications (GSM), enhanced data rates for GSM evolution (EDGE), 3G, 4G, 4G long-term expansion (LTE), worldwide interoperability for microwave access (WiMAX), Ethernet, the Internet, and other wireless and wired electronic communication protocols.

Services 190 can include remotely hosted websites or search engines that can be accessed using a general purpose or non-specialized application, such as a web browser. Accordingly, services 190 can include backend processes that, in response to receiving input from the electronic device 103, perform various functions to generate results that are accessible via one or more universal or platform-agnostic computer readable languages, such as hypertext mark language (HTML). In contrast, application support services 180 can include remotely hosted backend applications and services that can be accessed using specialized applications. Such specialized applications can be locally executed on the electronic device and include user interfaces, security or encrypting functionality, or other specialized functionality that is specific to or required for accessing results or other information from an associated application support service 180. For example, a banking application associated with a particular bank or financial institution can include proprietary encryption routines for encrypting and/or verifying the credentials of a user before a user can access financial information from the particular bank or financial institution. Similarly, a mapping or navigation application associated with a particular map database can include a specialized reader for decoding proprietary compressed map data stored in the map database.

In yet other embodiments, results engine 109 can be coupled, via network interface 150 and network/cloud 160, to remote category database (DB) 170. In some embodiments, the results engine 109, text selector/input device 105, display/UI device 107 can be embodied in a combination of software, firmware, and hardware in one or more electronic devices 103. In related embodiments, the electronic device 103 can locally execute applications 140, using a local processor and memory. Such memory can include volatile and non-transitory computer readable media in the electronic device.

Text selector/input device 105 can include various types of standardized or specialized computer-user interface devices, such as touchscreens, keyboards, computer displays, keyboards, mice, styli, microphones, speakers, motion sensors, etc. In related embodiments, the text selector/input device 105 can include a graphical user interface (GUI) generator for displaying a GUI on the display device/UI 107. Such GUIs can include various types of text selection tools that a user can operate to indicate a selection of text displayed on device/UI device 107. In such embodiments, the text displayed on the device/UI device 107 can be generated by an active or a background application being run on electronic device 103. In other embodiments, the text selector/input device 105 can include a connection to one or more external applications that provide text data as output.

The network interface 150 and cloud/network 160 can allow electronic communication between the results engine 130 and services 190, application services 180 and the remote category database 170. In such embodiments, the services 190, application services 180, and remote category database 170 can be hosted and/or executed as a combination of software, firmware, and hardware in one or more remote server computers. Accordingly, the services 190, application services 180, and remote category database 170 can be, or be included in, memory or memory portions of remote computers or server computers.

In some embodiments, the results engine 109 can include a number of subcomponents or subroutines including, but not limited to, an application selector 110, an applications handler 120, and a results handler 130. Application selector 110, applications handler 120, and results handler 130 can be software executed by computer processors, or components of computer processors in the electronic device 103. The application selector 110 can receive a selection of text from the text selector/input device 105. In response to receiving the text, the application selector 110 can analyze the characteristics of the text to determine a category associated with the text. Such analysis of the received text can include analyzing the structure, format, and content of the text. For example, the application selector 110 can determine that the selected text includes various types of data including, but not limited to, dates, names, locations, telephone numbers, and websites. In such embodiments, the application selector 110 can locally determine the category of the text. The application selector 110 can then send a command to the application handler 120 to execute a number of local applications 140 associated with the category. For example, the application selector 110 can instruct the application/service handler 120 to execute searches on local data stored on the electronic device 103, such as email messages, SMS messages, contact lists, address books, etc. In some embodiments, the electronic device 103 can share data and computing resources with another ancillary or complementary device, such a HUD glass or a wristwatch connected to the electronic device through a wired or wireless communication connection, e.g., Bluetooth. In such embodiments, the electronic device 103 can search on data stored on the ancillary device, and the ancillary device can search data on the electronic device 103.

In other embodiments, the application selector 110 can send a data request message the can include the text data to remote category database 170, via the network interface 150 and/or the network/cloud 160. In such embodiments, the remote category database 170 can include a relational database of words, terms, key words, phrases, titles, names, etc. with specific categories that can categorize all or some of the text data received by the application selector 110. For example, the application selector 110 can receive the title of the movie. In situations in which the application selector 110 may not be able to determine locally that the random string of words in the text data indicates a movie category, by referencing or querying a remote category database 170 the application selector 110 might recognize that some portion of the text data includes a movie title, and in response, send a response message to the application selector 110 indicating that the text data includes the context of the movie.

Once the application selector 110 analyzes or otherwise determines a particular category associated with the text data received from the text selector/input tool 105, the application selector 110 can determine a set of applications relevant to the category. Such sets of applications can include predetermined or dynamically determined sets of applications.

The application selector 110 can send a command message to the application/service handler 120 that includes instructions for executing the determined sets of applications. The application/service handler 120 can then execute the sets of applications using some or all of the selected or received text data as input. In some embodiments, the applications service handler 120 can execute each of the local applications 140, remote services 190, and application support services 180 in parallel, thus reducing the amount of time to receive the results from the applications. The application/service handler 120 can asynchronously receive the results from each of the local and remote applications and send the results to the results handler 130. Results handler 130 can receive results from the various local and remote applications, determine the relevance of the results, and then rank the results according to the determined relevance of the results.

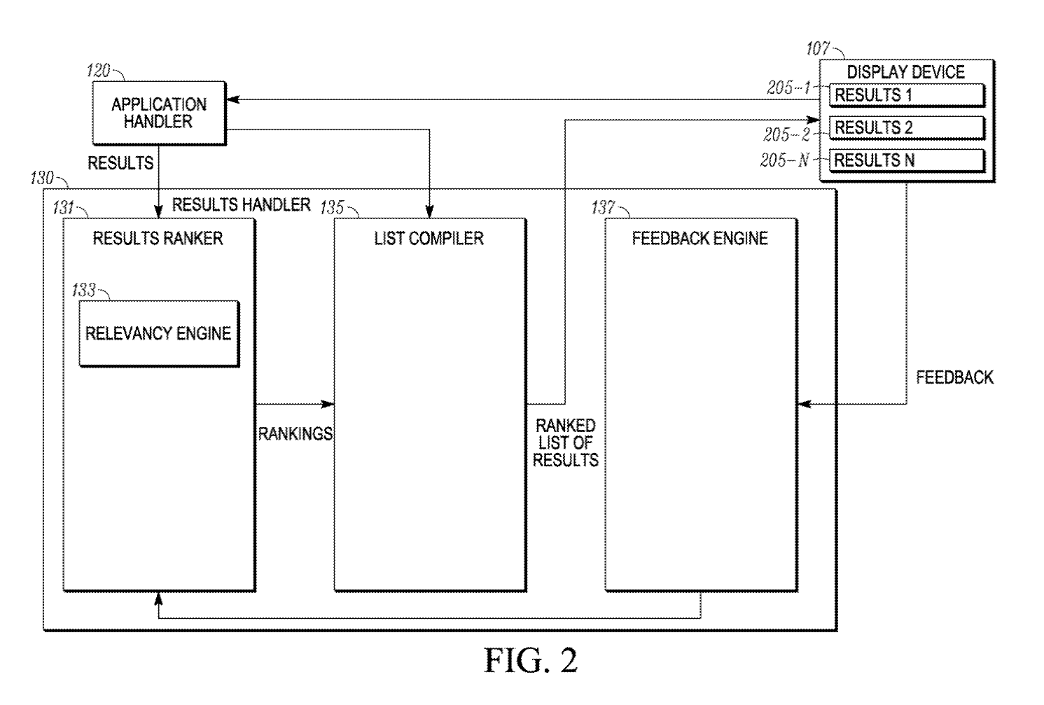

The functionality of the results handler 130 will now be discussed in more detail in reference to FIG. 2. As shown, results handler 130 can include a number of subcomponents, such as a results ranker 131, a list compiler 135, and a feedback engine 137. The results handler 130, the results ranker 131, the list compiler 135, and the feedback engine 137 can all be software executed by a processor or a processor portion in electronic device 103.

The results ranker 131 can receive results from application handler 120. The results provided by application handler 120 can be output from multiple applications predictively determined to be potentially relevant to a particular set of text or other context data. Using the results ranker 131, the results handler 130 can determine a ranked order for the results corresponding to an estimated relevancy or strength of the results. In some embodiments, the stronger or the more relevant the results are, the higher the associated ranking in the ranked order. Accordingly, results from an application that is determined to be highly relevant can be ranked higher than results from an application determined to be only moderately relevant. In some embodiments, the results ranker can also include a relevancy engine 133 that can include functionality for generating a relevancy score based on the results. The relevancy score can include metrics for quantitatively describing the strength of each of the results. In some embodiments, the higher the relevancy score for a particular result indicates a stronger or more relevant result. Accordingly, the results ranker 131 can rank the results according to the relevancy scores generated by the relevancy engine 133.

In one embodiment, the results ranker 131 can send the rankings of the results, along with application identifiers associated with the applications that produced the results, to the list compiler 135. List compiler 135 can generate a ranked list according to the rankings that can be rendered as results 205 in a graphical user interface on the display device 107. The graphical user interface on the display device 107 can include controls for launching the application associated with each of the results. In related embodiments, the ranked list can also include a preview or an abbreviated version of the results that a user can view to help him or her make a decision as to which, if any, of the displayed results are relevant for his or her intended purposes. For example, the ranked list can include entries for each of the results. Each of the entries can include an icon representing the associated application that produced the particular result and a brief summary or synopsis of the results. The brief summary or synopsis of the results can include a thumbnail or a brief text based description.

Once the ranked listing is displayed, the feedback engine 137 can determine feedback that can be used in the future to provide more relevant results 205. For example, the feedback engine 137 monitor user input from the user interface that includes the ranked results 205 displayed on display device 107 for actions taken by the user with respect to results 205. In some embodiments, the feedback engine 137 can detect whether user input is received that includes a command to launch one of the applications associated with one or more of the displayed ranked results 205. For example, a user may decide to launch the application associated with the results 2 shown at 205-2. Since the results 2 shown at 205-2 were listed second in the ranked list of results 205, the feedback engine 137 can detect that the second listed result was chosen over the first ranked results 1 shown at 205-1. Such information can be fed back into the results ranker 131 for use in future predictive determination of potentially relevant results associated with a particular set of text data or other context data that initiated the predictive application selection. Additionally, such information regarding which of the results 205 were selected can also be used to inform the determination of relevancy scores and/or the rankings of results.

In some scenarios, the predictive application selection process may be unsuccessful in producing results that meet the user's needs. For example, various embodiments of the present disclosure can detect that the user has dismissed or closed the ranked listing of results 205 and/or exited the predictive application selection mode. In such embodiments, the feedback engine 137 can monitor user input for some period of time after the ranked listing of results 205 is dismissed or closed to detect user input that indicates that the user has entered the same text data that was used to produce the ranked listing of results 205 into an application that was not previously listed in the ranked listing of results 205. In such embodiments, the feedback engine 137 can send information regarding which application the user independently launched back to the results ranker 131 or application selector 110. The results ranker 131 can use such information to infer that, in the future, the application that the user ultimately selected and launched should be considered to be listed in the ranked results when text is selected in similar contexts.

The period during which the feedback engine 137 can monitor user input after the ranked listing the results 205 is dismissed or closed can vary, according to various embodiments of the present disclosure. For example, the feedback engine 137 can monitor user input for a predetermined or dynamically determined period of time. In related embodiments, the dynamically determined period of time can be based on the complexity of the results and/or the range of associated relevancy scores produced by the relevancy engine 133. In other embodiments, the period of time for which the feedback engine 137 monitors user input can be based on or determined by a predetermined or dynamically determined number of observed user inputs or interactions. For example, the feedback engine 137 may monitor the next ten user inputs or the feedback engine 137 can monitor for two minutes whether or not the user enters or pastes the same text data that was used to generate the results from the ranked listing of results 205. After ten user inputs or two minutes without detecting the particular text data being entered or input into another application that was not previously listed in the ranked list of results 205, the feedback engine 137 may assume that the user has moved on from a particular task, and stop monitoring user input.

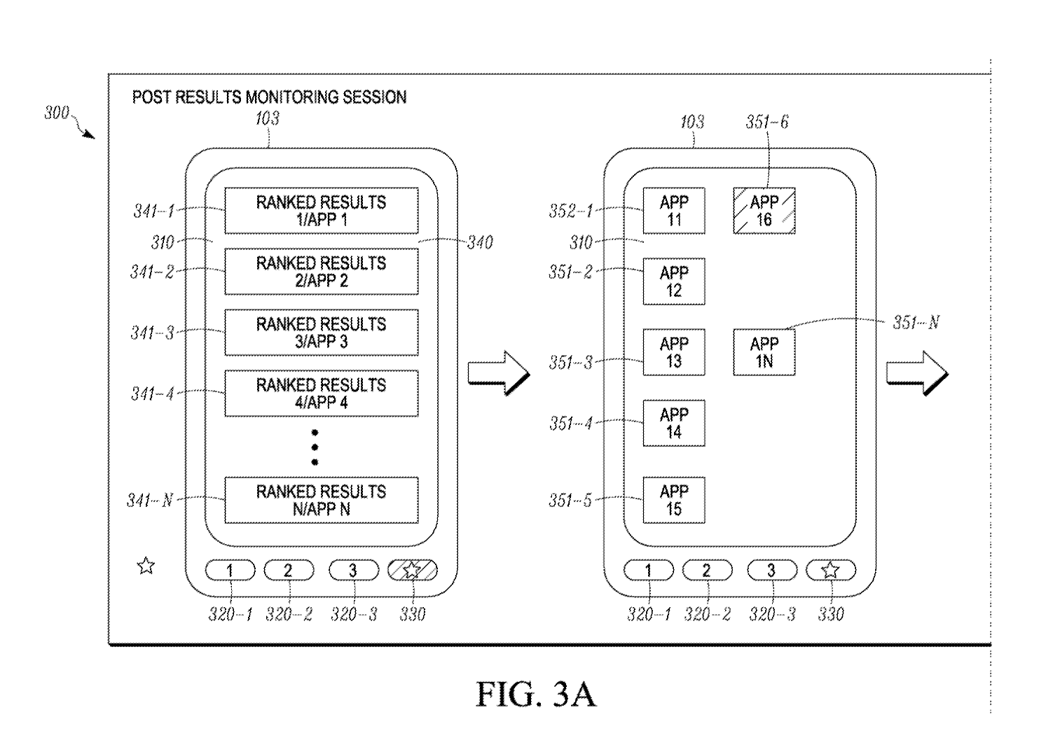

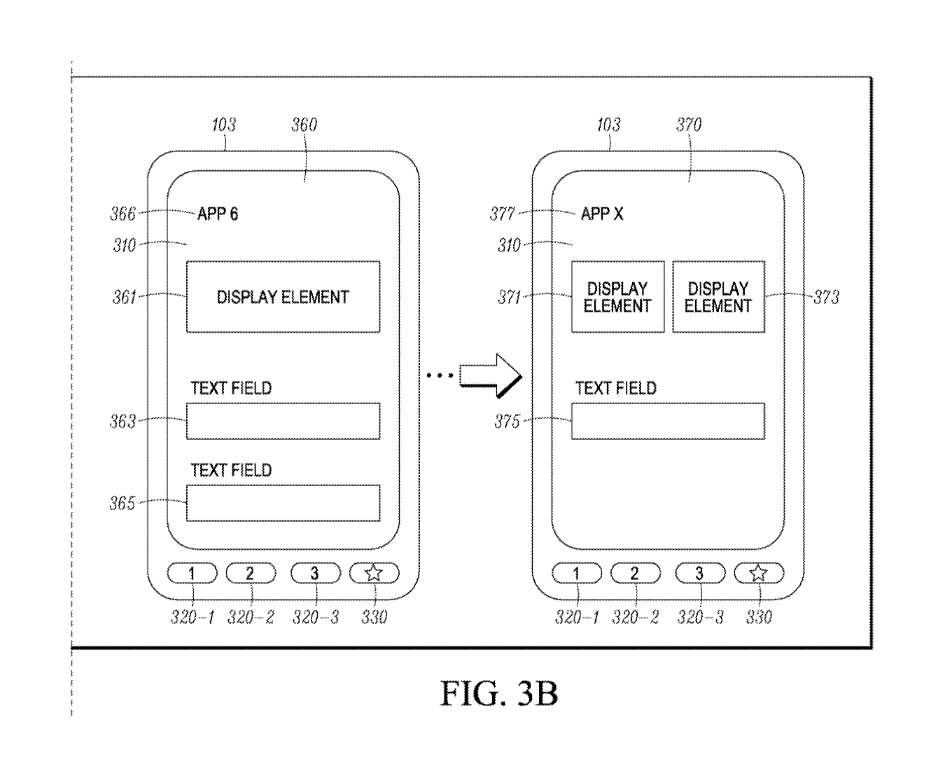

FIGS. 3A and 3B illustrate a post results monitoring session 300, according to various embodiments of the present disclosure. As illustrated, electronic device 103 can include a display device 310. The display device 310 can include various types of interactive touch sensitive devices, such as touchscreens or touchpads, that can display virtual or multipurpose controls for receiving user input or commands. In some embodiments, electronic device 103 can also include dedicated or physical controls 320 and 330. Controls 320 and 330 can include physical buttons or switches and/or keyboards. In related embodiments, physical buttons or switches can include a display or other indicator that can programmatically be changed to alter the specific single function associated with the buttons or switch. For example, each of controls 320 or 330 can include a display device or light that can be changed to indicate that the associated control 320 or 330 is active for a particular purpose or function. In some embodiments, control 330 can be permanently or temporarily configured to be operable to initiate a predictive application selection mode that supersedes or is invoked to run concurrently with one or more other active applications on electronic device 103. In such embodiments, the predictive application selection mode can operate in the operating system or in the middleware of the architecture of electronic device 103.

Display device 310 of electronic device 103 can be configured to display, in response to user inputs, graphical user interfaces 340, 350, 360, and 370. In the particular example shown in the post results monitoring session 300, electronic device 103 can display a rendered list of ranked results/applications (results/apps) 341 in user interface 340. In such embodiments, the rendered list of ranked results/applications 341 can include as many as N results, where N is a natural number. In some embodiments, electronic device 103 receives user input selecting one of the ranked results/applications 341. For example, a user may select the rendered representation with his/her finger or stylus. In such embodiments, the feedback engine 137 can detect that the user input includes a command or other indication of a selection of one of the displayed ranked results/applications 341. Such information can then be used by various other aspects of the present disclosure to improve their respective functionality or efficacy.

However, in some embodiments a user may not choose to enter user input to select one of the ranked results/applications 341. In such scenarios, the user might use one of controls 320 or 330, or some other control, to close the rendered list of ranked results 341 and to display a graphical user interface 350. The graphical user interface 350 can include a number of icons representing different applications (apps) 351. In some embodiments, the feedback engine 137 can be configured to monitor the user input enter through graphical user interface 350. For example, after having closed or dismissed the graphical user interface 340 that was displaying the rendered list of ranked results/applications 341, a user may choose to launch an application represented by icon application 16 shown at 351-6 by selecting the respective icon. In response to the user input to select the icon of application 16 shown at 351-6, electronic device 103 can render a graphical user interface 360 of application 6 shown at 366 on the display device 310. The rendered graphical user interface 360 can include a number of elements, such as a display element 361, e.g., a picture or a logo, and various text fields 363 and 365. In such embodiments, the feedback engine 137 can monitor user input or data entered into one or more of the text fields 363 or 365. If the same text data that was used by applications to produce the ranked results/applications 341 is inputted, then the feedback engine 137 can record the name or identifier associated with application 6 shown at 366. Such information can then be fed back to the results handler 131, and other components of the present disclosure, to be used or considered when ranking relevant results for predictively selecting applications in the future. Accordingly, the information can then be used by the device of the user that made the selection and as a factor in relevancy determination for device of other users in a population of users.

If the predetermined amount of time or some predetermined number of user inputs after the user exits or otherwise dismisses the rendered list of ranked results/applications 341 has yet to expire or pass, when an application X shown at 377 is displayed in user interface 370 on display device 310, feedback engine 137 may continue to monitor user input on application X. As shown, user interface 370 can include various display elements 371 and 373, such as rendered pictures or graphics, as well as the text field 375. The feedback engine 137 can monitor the content of the display elements 371 and 373 as well as text field 375 to detect if the user enters or pastes the text data that was used by the applications to produce the ranked results/applications 341. If the feedback engine 137 does detect that the user inputs the relevant text data into the text field 375, then the feedback engine 137 can record and send the application name or application identifier associated with the application X shown at 377 to the various other components of the present disclosure for use in ranking relevant results or for predictively selecting applications in the future.

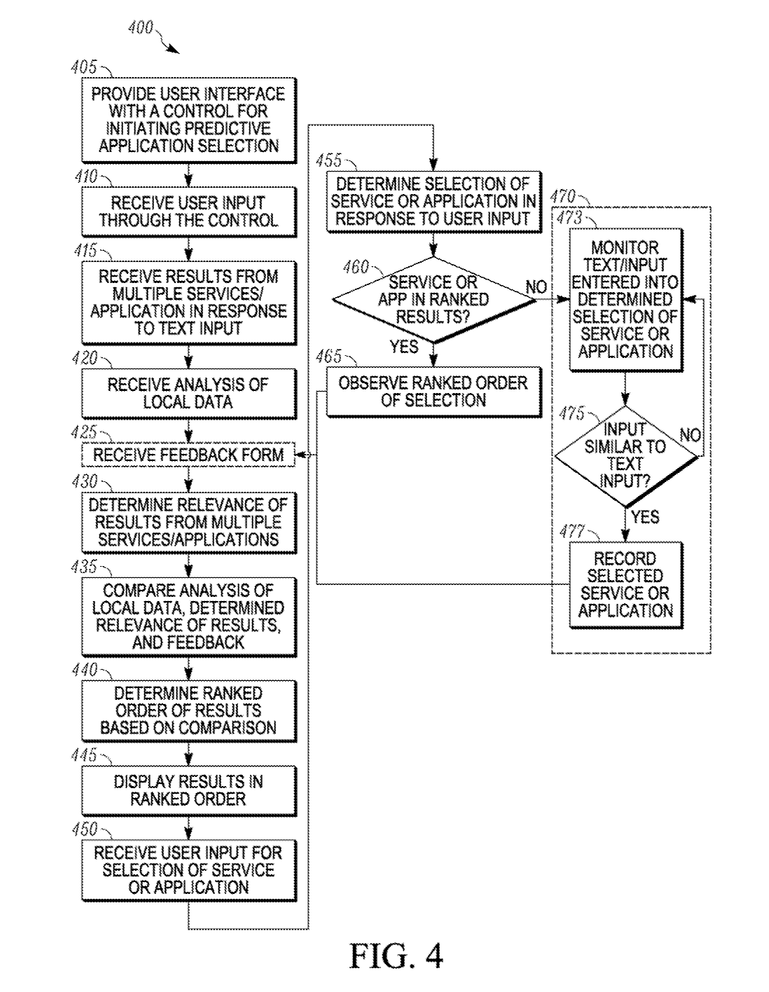

FIG. 4 is a flowchart of a method 400 for initiating predictive application selection mode and displaying ranked results from multiple applications with improving feedback, according to various embodiments of the present disclosure. Method 400 can begin at action 405, in which electronic device 103 can provide a user interface with one or more dedicated or multifunction controls for initiating predictive application selection mode. In other embodiments, the control for initiating predictive application selection mode can include a physical button or switch.

In some embodiments, the predictive application selection mode puts electronic device 103 into mode in which the text data displayed in a display device of the electronic device 103 by an active application can be selected and/or entered. For example, the predictive application selection mode can superimpose one graphical user interface over the graphical user interface of the active application to allow the user to highlight or otherwise select text data or rendered text shown by the graphical user interface of the active application. According to various embodiments of the present disclosure, in response to selecting text data, the electronic device can predict multiple applications or services that may be potentially relevant to the user or the users intended task based on the text data and/or other contexts of the user or the electronic device.

In action 410, electronic device 103 can receive user input through the control to initiate the predictive application selection mode. Once electronic device 103 has predictively selected and executed some number of applications, the electronic device can receive or collect the results from the multiple services and applications in which the selected text data was used as input. In such embodiments, some of the results may be more relevant than other results for the user or the user's intended purposes. Accordingly, in actions 420 through 435, the electronic device 103 can determine the relevance or strength of the results and rank the results accordingly.

For example, in action 420, electronic device 103 can receive analysis of local data resident in one or more memories of the electronic device 103. Such analysis can include determination of whether there is a locally stored record that includes a close or exact match for the selected text data. In such embodiments, electronic device 103 can infer that text data that has an exact match with data in a record stored locally will be highly relevant to the user. In some embodiments, electronic device 103 can also receive or collect feedback in action 425 from previous user interactions that can be used to inform the determination of relevance of results from the multiple services and applications in action 430. For example, the electronic device 103 can receive feedback from action 470 of a previously executed implementation of a method 400 that included the selected text data used by the applications to produce the results. If a user has selected or launched a particular application in the past when a particular word or phrase was selected or entered for the predictive application selection process, then the electronic device 103 can infer the user selected or preferred application should be rated as being more relevant than other possible applications.

In action 435, electronic device 103 can compare the analysis of the local data, e.g., the determination of whether the selected text data is a close or exact match to data stored locally on the electronic device, with the determined relevancy of the results and feedback. Based on the comparison of the local data analysis, the determined relevancy of the results, and the feedback, electronic device 103 can determine a ranked order of the results, in action 440. In some embodiments, results determined to be relevant that match data stored locally, and come from applications that are preferred by the user based on feedback, can be ranked higher than the results that are determined to be less relevant, do not match data stored locally, and originate from applications that are less preferred or previously unused.

In action 445, electronic device 103 can display the results in the ranked order on a display device of electronic device 103. In some embodiments, displaying the results in the ranked order can include generating or rendering a graphical user interface that includes a listing of the results in the ranked order. Such listings of the results in the ranked order can include links or controls operable by a user to launch or browse the application or service to view the results in more detail. Accordingly, such listings of the results in the ranked order can also include truncated, preview, or synopsis views of the results to inform the user and help him or her decide which of the ranked results will be the most useful for his or her purposes.

With the results displayed in the ranked order in the user interface on the display device of electronic device 103, the electronic device 103 can receive user input indicating a selection of one or more services or applications, in action 450. For example, in embodiments in which the electronic device 103 includes a touchscreen as the display device, the graphical user interface displaying the ranked results can be configured to launch or instantiate an associated application with the selected text data as input when a user operates a corresponding icon or control, e.g., tapping the icon with his or her finger. In response to user input, electronic device 103 can determine the selection of services or applications, in action 455. In some scenarios, the user input received in action 455 may be received through the graphical user interface that includes the listing of ranked results, in other scenarios, user input received in action 455 may be received through a graphical user interface different from the graphical user interface that includes the list of ranked results. For example, the user input may be received after the user has dismissed or closed the graphical user interface that includes the list of ranked results. In such embodiments, is possible that the user has navigated to the “home screen” of the operating system of electronic device 103 and launched an application using the general-purpose navigation user interface of the electronic device 103 to launch an application or service that was not included in the list of ranked results. Accordingly, electronic device 103 can determine whether or not the launched service application was listed in the ranked results in determination 460.

If at determination 460, electronic device 103 determines that the service or application that was ultimately launched by the user with the selected text as input was included in the list of ranked results, then the electronic device 103, in action 465, can observe the name, identifier, and or the rank position in the list of ranked results associated of the particular application that the user ultimately launched. Such information can be used as feedback to better inform the predictive selection of applications and the determined relevancy of the results in future invocations of the predictive application selection mode.

However, if at determination 460, electronic device 103 determines that the service or application that was ultimately launched by the user with the selected text as input was not included in the list of ranked results, then the electronic device 103 can be configured to enter into a monitoring period 470. During the monitoring time period 470, electronic device 103 can monitor, in action 473, the text and user input entered into the determined service or application to detect whether or not the input or text is similar to the originally selected text in determination 475. If the monitoring period 470 has not expired and the input entered into the determined application does not match the selected text used by the applications to generate the ranked results, then the electronic device can continue to monitor in action 473. If, however, at determination 475, electronic device 103 determines that the input entered into a particular application or service is similar to the selected text used by the applications to generate the ranked results, then the electronic device 103 can record the selected service or application in action 477. Recording the selected service or application can include recording or storing a name or identifier associated with the determined service or application. Such information can then be sent back as feedback to action 425.

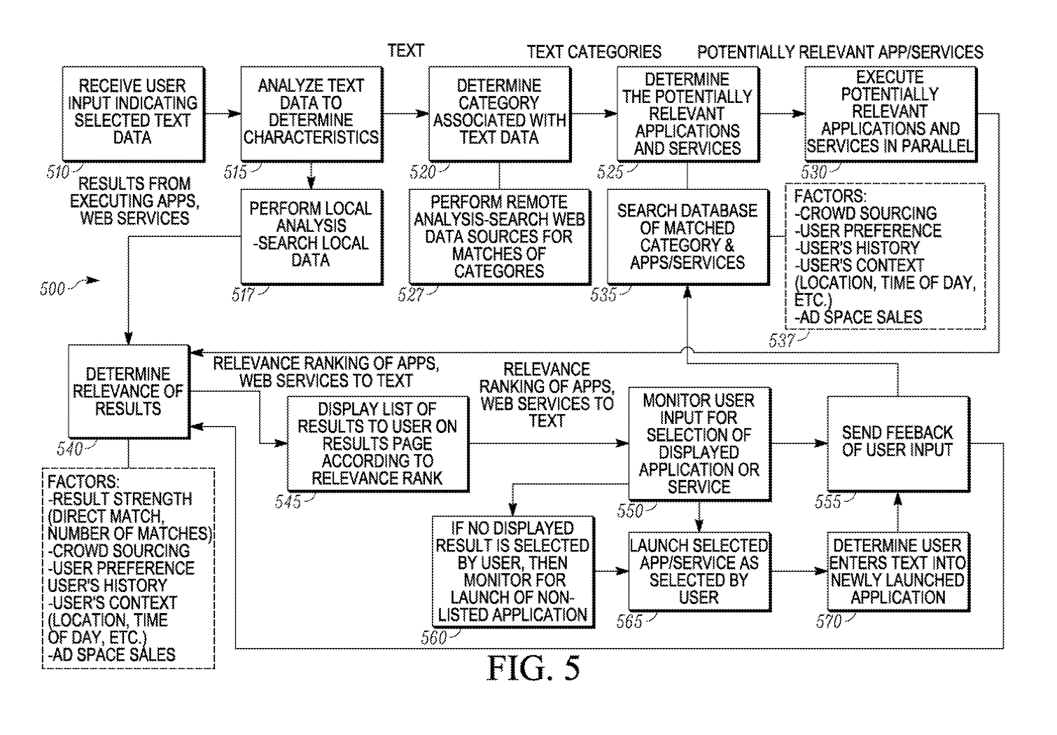

FIG. 5 is a flowchart of a method 500 for improving user interactions with various electronic devices 103, according to various embodiments of the present disclosure. Accordingly, FIG. 5 also shows a data flow among the various actions or processes of electronic device 103 according to various embodiments of the present disclosure. In block 510, electronic device 103 can receive text as input. In some embodiments, receiving text as input can include receiving an indication of a selected piece of text. In other embodiments, receiving the text as input can include performing voice recognition on voice input into the electronic device.

In yet other embodiments, the text data can be embedded in an image or image data displayed on a display device of the electronic device. In such embodiments, optical character recognition (OCR) operations, and other text extraction operations, can be performed to extract the text data from the image data. For example, some applications perform their own image rendering and do not output text data to the operating system, the graphics engine, or the display. In related embodiments, the image output to the display of electronic device can be captured using various techniques for print-screens or screen captures. Once the image of the screen is captured, the text extraction operation can be performed to extract text that can be input for block 510.

In another embodiment, electronic device 103 may be equipped with a camera device that can be used to capture an image of a scene that includes text information, e.g., a photograph of a book, a photograph of a street sign, a photograph of a storefront sign. Once the image is captured, various text extraction operations can be performed to extract the real world text data directly from the captured image. Such text can then be received as input in block 510.

Once the text data is determined, it can be sent to block 515. In block 515, the text data is analyzed to determine the character of the text data. Various aspects of the text data, including the character of the text data, can be analyzed to determine what kind of information might be included in the text data. For example, the text data can be determined to include a phone number, a time or date, a name, an address, or a social media login identifier. If the analysis of block 515 determines that the content of the text data includes information that might be found in data stored locally on the electronic device, the text data can be sent for analysis in block 517. In block 517, a search can be performed on the local data. Such local data can include local client data including information regarding locally stored contacts, calendar entries, call logs, email, SMS messages, etc. The determination of matching data stored locally on electronic device 103 can be used in later processes to determine or weight the relevance of the results returned from various applications.

Once the initial analysis of the input text data is complete, the actual text can be sent to block 520 to determine a category that matches the text. The determination of a category can be based on information in text-category database 170 where the text is determined to match terms such as, keywords, phrases, or titles, with categories. For example, if the input text data is determined to be a name, the analysis of the actual text can determine the text is associated with a celebrity, movie star, politician, and/or be associated with the name of a book or a movie. At 527, various embodiments of the present disclosure can use both locally stored and remotely hosted text-category databases that can be created, maintained, or augmented by the user of the local electronic device and/or other users or entities.

Once one or more categories that match the text are determined, the text categories can be sent to block 525 to determine an initial set of relevant applications that have been predetermined or dynamically determined to be potentially relevant to the determined category. In some embodiments, the determination of the initial set of potentially relevant applications can be based on a search of one or more databases of a category-application databases at block 535. Such databases can be stored locally on electronic device 103 and/or hosted on a remote server accessible over one or more communication standards. In related embodiments, each of the category-application databases can include a listing of associated categories applications based on a number of factors at block 537. The factors can include input from various forms of data including, but not limited to, crowd sourced information, user preference information, user's history of the electronic device, content associated with the user, as well as other objective information such as time, location, and date.

In related embodiments, the initial set of potentially relevant applications can be determined in view of paid advertising. For example, in consideration of the user's recent use of electronic device 103, which can include the user's location, recent search engine searches, recently run applications, as well as any other potentially relevant information, new and previously uninstalled or unused applications that may be potentially relevant to the category or input text can be suggested and or automatically run to return results that use the text data as input. For example, a user may have recently used a navigation application on his or her smart phone to find directions to a local hardware store. Once the user is determined to be in the parking store of the hardware store, and the electronic device has determined that the user is walking in the parking lot toward the store, various embodiments of the present disclosure can use such information for informing the determination of the initial set of potentially relevant applications. In such embodiments, if the user or an application inputs or otherwise indicates a selection of text data regarding a particular material or tool that might be found in the hardware store, block 535 can be used to suggest an application that might be downloaded and/or executed on the user's smartphone to help him/her find what he/she is looking for in the hardware store. For example, the particular hardware store to which the user is walking might have published an application specific for that hardware store. Such an application might show the user where various materials and tools are located within the store. Similarly, manufacturers of items in the store can also use such user specific information to advertise or provide applications to the user in response to the entry of specific text data.

Just as the text can match with one or more categories, the matched sets of potentially relevant applications can match with multiple categories. Accordingly, the initial set of potentially relevant applications can include multiple subsets of applications associated with multiple categories. The sets of potentially relevant applications can then be presented to the user either as a choice to operate or execute a particular application in other embodiments, some or all of the entire sets of the initial sets of potentially relevant applications can be executed automatically without further user input in block 530. Such embodiments can thus provide the user with a set of results from each of the applications using the text data as input without the user manually executing each of the applications with the text data as input. Block 530 can also include receiving the results for each of the applications simultaneously in a single message or asynchronously as each of the applications provide the results. In particular the results from executing the applications using the text data as input can be sent to block 540 to determine the relevance of the results. To determine the relevance of the results, the results can be analyzed to determine the strength of the results. In some embodiments, the strength of the results can be determined by various functions that generate a related relevance score. In such relevance score operations, the higher the relevance score, the more relevant results.

In related embodiments, at 540, the relevance of the results can be determined in consideration of various factors. Such factors can include, but are not limited to, the results from the analysis of the input text data in blocks 515 and 517 in view of the locally stored data on electronic device 103. For example, if the results from a social media networking search application returns the same results of a person's name found in context data stored in electronic device 103, then those results might be determined to be highly relevant. The factors can also include weighting values based on information from crowdsourcing information, user preferences, user's history, user's context, as well as advertisement space. For example, an operator or service provider providing services to the electronic device implementing various embodiments of the method 500 can sell priority listing rights to an advertiser such that the results from their application can be determined to be highly relevant with respect to the matched category or text data.

Results from various applications can be ranked according to determine relevance results. The results, along with a link or other control for invoking or launching the associated application that provided the results, can be displayed to the user according to the ranked order in block 545. Once the ranked results are displayed to the user, the electronic device 103 can receive a user selection of one of the displayed results to launch the application or view the full version of the results from the application in block 550. In response to the selection of results, the electronic device 103 can launch the selected application or display the full version of the results in block 565. In related embodiments, the user can be presented with a back button to return the list of ranked results.

On occasion, the initial set of potentially relevant applications and/or the determination of the relevance of the results from the applications can be inaccurate or not especially appropriate or applicable to the user's intended use of the text data. In such situations, the electronic device 103 can monitor user input to determine if none of the displayed ranked results are selected by the user in block 560. In such scenarios, the user may exit from the display of the ranked results and launch a completely different non-displayed application. The non-displayed application can then be launched in block 565. In various embodiments, electronic device 103 can determine if the user pastes or enters the same text data into an application that was not previously displayed in the ranked results in block 570. In such embodiments, the information regarding the application that was actually used by the user, e.g., an association between the manually entered text data and the application that was ultimately launched, can be used in analysis for determining future relevance of the particular application that the user did use with similar or related text data in box 555. In such embodiments, electronic device 103 can learn which applications the user of the electronic device actually uses or prefers when certain text data is entered or otherwise indicated. In one embodiments, the electronic device 103 can provide the user with explicit prompts for user feedback. For example, in the event that the user exits the ranked listing of potentially relevant results without selecting any of the results or using any of the associated applications provided in block 560, then part of the observation of user input of block 570 can include prompting the user for an indication of an application that the user thinks or knows to be relevant to the text data. In other embodiments, the observation of user input in block 570 can be automatic and completed as a background process without the user being aware or requiring any additional user input. The automatic observation or monitoring of user input after the user exits or dismisses the listing of potentially relevant results can be limited to a predetermined amount of time, limited to a predetermined number of user input entries, or limited to user input that includes or is related to the text data that initially initiated the processes beginning at block 510. While observing user input for similar or related text data to be entered into another application, the system can record any application into which the user might enter the text data and analyze the results to determine the relevance or strength of the returned results. The information regarding the recorded application, e.g., an application name or identifier, and information regarding the strength of the results, e.g., the result relevance score, can be provided to block 555 to increase the basis of the crowd sourced data and augment the particular user's preferences. The augmented crowd sourced data and the user preferences can then be used to update the category-application database.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
providing, in an electronic device, a control to initiate a predictive application selection mode, wherein the predictive application selection mode causes display of a first graphical user interface that is superimposed over a second graphical user interface on a display device of the electronic device;
receiving, in the electronic device, a first user input through the control,
initiating, in the electronic device, the predictive application selection mode in response to the first user input;
receiving, in the electronic device, a second user input through the first user interface;
determining, in the electronic device, a plurality of results from a plurality of applications, wherein the second user input is available to the plurality of applications as input;
determining, in the electronic device, a ranked order of the plurality of results; and
displaying, in the electronic device, a third user interface comprising a list of the at least a portion of the plurality of results based on the ranked order.

2. The method of claim 1, wherein the second user input comprises text data.

3. The method of claim 1, wherein the control comprises a dedicated physical button associated with the electronic device.

4. The method of claim 1, wherein:
the control comprises a virtual button displayed on the display device of the electronic device, and
the display device comprises a touchscreen.

5. The method of claim 4, wherein the first user interface comprises a text selection tool for selecting text displayed in the second user interface.

6. The method of claim 1, wherein the list of the at least a portion of the plurality of results comprises a plurality of icons associated with the plurality of applications and a plurality of result previews.

7. The method of claim 1, further comprising:
receiving, in the electronic device, a second user input through the third user interface comprising a selection of one or more of the at least a portion of the plurality of results; and
recording, in the electronic device, the second user input as feedback associated with the plurality of applications, the plurality of results, or the ranked order.

8. The method of claim 1, further comprising:
receiving, in the electronic device, a second user input through the second user interface comprising a command to close the third user interface;
detecting, in the electronic device, a third user input comprising a command to launch an application not in the list of at least a portion of the plurality of results;
detecting input of the second user input in the launched application; and
recording, in the electronic device, an application identifier associated with the launched application, wherein the application identifier is used as feedback in a future determination of a plurality of applications or a future determination of a ranked order of results.

9. A non-transitory computer-readable storage medium containing instructions that, when executed, control an electronic device to be configured for:
providing a control to initiate a predictive application selection mode, wherein the predictive application selection mode causes display of a first graphical user interface that is superimposed over a second graphical user interface on a display device of the electronic device;
receiving a first user input through the control,
initiating the predictive application selection mode in response to the first user input;
receiving a second user input through the first graphical user interface;
determining a plurality of results from a plurality of applications, wherein the second user input is available to the plurality of applications as input;
determining a ranked order of the plurality of results; and
displaying a third user interface comprising a list of the at least a portion of the plurality of results based on the ranked order.

10. The non-transitory computer-readable storage medium of claim 9, wherein the second user input comprises text data.

11. The non-transitory computer-readable storage medium of claim 9, wherein the control comprises a dedicated physical button associated with the electronic device.

12. The non-transitory computer-readable storage medium of claim 9, wherein:
the control comprises a virtual button displayed on the display device of the electronic device, and
the display device comprises a touchscreen.

13. The non-transitory computer-readable storage medium of claim 12, wherein the first user interface comprises a text selection tool for selecting text displayed in the second user interface.

14. The non-transitory computer-readable storage medium of claim 9, wherein the list of the at least a portion of the plurality of results comprises a plurality of icons associated with the plurality of applications and a plurality of result previews.

15. The non-transitory computer-readable storage medium of claim 9, wherein the instructions that, when executed, control the electronic device further to be configured for:
receiving a second user input through the third user interface comprising a selection of one or more of the at least a portion of the plurality of results; and
recording the second user input as feedback associated with the plurality of applications, the plurality of results, or the ranked order.

16. The non-transitory computer-readable storage medium of claim 9, wherein the instructions that, when executed, control the electronic device further to be configured for:
receiving a second user input through the second user interface comprising a command to close the third user interface;
detecting a third user input comprising a command to launch an application not in the list of at least a portion of the plurality of results;
detecting input of the second user input in the launched application; and
recording an application identifier associated with the launched application, wherein the application identifier is used as feedback in a future determination of a plurality of applications or a future determination of a ranked order of results.

17. An electronic device comprising:
one or more computer processors; and
a non-transitory computer-readable storage medium containing instructions, that when executed, control the one or more computer processors to be configured for:
providing, in an electronic device, a control to initiate a predictive application selection mode, wherein the predictive application selection mode causes display of a first graphical user interface that is superimposed over a second graphical user interface on a display device of the electronic device;
receiving a first user input through the control,
initiating the predictive application selection mode in response to the first user input;
receiving a second user input through the first graphical user interface;
determining a plurality of results from a plurality of applications, wherein the second user input is available to the plurality of applications as input;
determining a ranked order of the plurality of results; and
displaying a third user interface comprising a list of the at least a portion of the plurality of results based on the ranked order.

18. The electronic device of claim 17, wherein the second user input comprises text data.

19. The electronic device of claim 18, wherein the first user interface comprises a text selection tool for selecting text displayed in the second user interface.

20. The electronic device of claim 17, wherein:
the control comprises a virtual button displayed on the display device of the electronic device, and
the display device comprises a touchscreen.

21. The electronic device of claim 17, wherein the list of the at least a portion of the plurality of results comprises a plurality of icons associated with the plurality of applications and a plurality of result previews.

22. The electronic device of claim 17, wherein the instructions that, when executed, control the electronic device further to be configured for:
receiving a second user input through the third user interface comprising a selection of one or more of the at least a portion of the plurality of results; and
recording the second user input as feedback associated with the plurality of applications, the plurality of results, or the ranked order.

23. The electronic device of claim 17, wherein the instructions that, when executed, control the electronic device further to be configured for:
receiving a second user input through the second user interface comprising a command to close the third user interface;
detecting a third user input comprising a command to launch an application not in the list of at least a portion of the plurality of results;
detecting input of the second user input in the launched application; and
recording an application identifier associated with the launched application, wherein the application identifier is used as feedback in a future determination of a plurality of applications or a future determination of a ranked order of results.
